(19) United States
(12) Patent Application Publication
(10) Pub. No.: US 2021/0231301 A1
(43) Pub. Date: Jul. 29, 2021

(54) HEAT CONDUCTING COMPOSITE PRINTED BY FDM AND STRATEGIES FOR EFFECTIVE HEAT SINKING

(71) Applicant: SIGNIFY HOLDING B.V., EINDHOVEN (NL)

(72) Inventors: Rifat Ata Mustafa HIKMET, EINDHOVEN (NL); Patrick ZUIDEMA, EINDHOVEN (NL); Paulus Albertus VAN HAL, EINDHOVEN (NL)

(21) Appl. No.: 17/052,867

(22) PCT Filed: May 15, 2019
(86) PCT No.: PCT/EP2019/062481

§ 371 Date: Nov. 4, 2020

(30) Foreign Application Priority Data
May 25, 2018 (EP) 18174237.0

(51) Int. Cl. F21V 29/77; B29C 64/209; B29C 64/118; F21V 29/87; B33Y 10/00; B33Y 70/00; B33Y 80/00

(52) U.S. Cl. CPC F21V 29/77; B29C 64/209; B29C 64/118; B29K 2507/04; B33Y 10/00; B33Y 70/00; B33Y 80/00; F21V 29/87

(57) ABSTRACT

The invention provides a method for 3D printing a heat sink (100) by means of fused deposition modelling, the method comprising layer-wise depositing a 3D printable material to provide a plurality of layers (322) of a 3D printed material (202) whereby a heat receiving face (101) of the heat sink (100) is created, the plurality of layers (322) of 3D printed material (202) being configured parallel to planes (325) perpendicular to the heat receiving face (101), wherein the 3D printable material comprises particles embedded in the 3D printable material, wherein the particles have an anisotropic thermal conductivity, wherein the particles are available in the 3D printable material in an amount selected from the range of 5-40 vol. % relative to the total volume of the 3D printable material, and wherein the layers (322) of 3D printed material (202) have layer heights (H) selected from the range of at maximum 800 μm.

### FIELD OF THE INVENTION

The invention relates to a method for manufacturing a 3D (printed) item, in particular to a method for 3D printing a heat sink by means of fused deposition modelling. The invention also relates to the 3D (printed) item obtainable with such method. Further, the invention relates to a system, such as lighting system, including such 3D (printed) item.

### BACKGROUND OF THE INVENTION

The use of thermally conductive materials is known in the art. WO2016/134984, for instance, describes thermally conductive composite materials comprising an ultrahigh molecular weight (UHMW) polymer and a filler material in an amount of greater than about 60 wt % and uses thereof, including in fused deposition modeling and 3D printing for making articles. The invention also relates to making the composite materials in solution. The composite materials possess desirable thermal conductivity and at least acceptable physical and/or mechanical properties.

### SUMMARY OF THE INVENTION

Within the next 10-20 years, digital fabrication will increasingly transform the nature of global manufacturing. One of the aspects of digital fabrication is 3D printing. Currently, many different techniques have been developed in order to produce various 3D printed objects using various materials such as ceramics, metals and polymers. 3D printing can also be used in producing molds which can then be used for replicating objects.

For the purpose of making molds, the use of polyjet technique has been suggested. This technique makes use of layer by layer deposition of photo-polymerisable material which is cured after each deposition to form a solid structure. While this technique produces smooth surfaces the photo curable materials are not very stable and they also have relatively low thermal conductivity to be useful for injection molding applications.

The most widely used additive manufacturing technology is the process known as Fused Deposition Modeling (FDM). Fused deposition modeling (FDM) is an additive manufacturing technology commonly used for modeling, prototyping, and production applications. FDM works on an “additive” principle by laying down material in layers; a plastic filament or metal wire is unwound from a coil and supplies material to produce a part. Possibly, (for thermoplastics for example) the filament is melted and extruded before being laid down. FDM is a rapid prototyping technology. Other terms for FDM are “fused filament fabrication” (FFF) or “filament 3D printing” (FDP), which are considered to be equivalent to FDM. In general, FDM printers use a thermoplastic filament, which is heated to its melting point and then extruded, layer by layer, (or in fact filament after filament) to create a three-dimensional object. FDM printers are relatively fast, low cost and can be used for printing complicated 3D objects. Such printers are used in printing various shapes using various polymers. The technique is also being further developed in the production of LED luminaires and lighting solutions.

In lighting applications for optimum functioning of LEDs efficient heat sinking is necessary. Thermal conductors based on polymeric materials and thermally conductive additives appear to have a relative low thermal conductivity and/or appear to be based on materials that are not easily 3D printed, such as via FDM, or are only 3D printable via specific routes, such as via a dilution stage. The same may apply for electrical conductors based on polymeric materials and thermally conductive additives. Further, the same may also apply to other applications than lighting applications.

Hence, it is an aspect of the invention to provide an alternative 3D printing method and/or 3D (printed) item which preferably further at least partly obviate(s) one or more of above-described drawbacks. The present invention may have as object to overcome or ameliorate at least one of the disadvantages of the prior art, or to provide a useful alternative.

Hence, in a first aspect the invention provides a method for 3D printing a 3D item (“item” or “3D printed item”) by means of fused deposition modelling, wherein the 3D item is a heat sink. The method comprises layer-wise depositing a 3D printable material to provide a plurality of layer of a 3D printed material whereby a heat receiving face of the heat sink is created. The plurality of layers of 3D printed material are configured parallel to planes perpendicular to the heat receiving face. The 3D printable material further comprises particles embedded in the 3D printable material, wherein the particles have an anisotropic thermal conductivity or an anisotropic electrical conductivity, especially an anisotropic thermal conductivity, wherein the particles are available in the 3D printable material in specific embodiments in an amount selected from the range of at maximum 40 vol. %, such as in the range of 5-40 vol. %, like in the range of 10-40 vol. %, even more especially at maximum 30 vol. %, relative to the total volume of the 3D printable material (in the respective layer), and wherein the method comprises providing layers of 3D printed material having layer heights (H), especially selected from the range of at maximum 1 mm, even more especially at maximum 800 μm. Especially, the 3D item is 3D printed by means of fused deposition modeling (3D printing).

With such method, it appears that a 3D item may be printed that has anisotropic conductive properties, such as anisotropic thermally conductive properties, that can essentially easily aligned in a desired orientation direction. First non-optimized experimental results provided thermal conductivities over 6 or even over 7 W/mK, especially at relative small layer heights. A large advantage of a 3D printed conductive item is that the dimensions may be relatively easily adapted. In this way, e.g. thermal conduction may be further optimized, as the thermal contact between the heat generating device and the heat sink may be optimized by optimizing the shape of the 3D printed item, which is relatively easy with 3D printing, such as FDM. Further, with 3D printing it may be possible to generate a thermally conductive material that is not electrically conductive. It surprisingly appears that by FDM printing, the anisotropic particles, especially having longest dimensions selected from the range of about 10-200 μm, and especially with deposited layer heights of at maximum about 800 μm, the particles are automatically aligned and provide the anisotropic conduction of the 3D printed item.

The herein described method provides 3D printed items. Hence, the invention also provides in a further aspect a 3D printed item obtainable with the herein described method. In a further aspect a 3D printed item obtainable with the herein described method. The (with the herein described method) obtained 3D printed item may be functional per se. The thus obtained 3D item may (alternatively) be used for decorative or artistic purposes.

The 3D printed item may include or be provided with a functional component.

The functional component may especially be selected from the group consisting of an optical component, an electrical component, a movable mechanical component, and a magnetic component. The term “optical component” especially refers to a component having an optical functionality, such as a lens, a mirror, a light source (like a LED), etc. The term “electrical component” may e.g. refer to an integrated circuit, PCB, a battery, a driver, but also a light source (as a light source may be considered an optical component and an electrical component), etc. The term magnetic component may e.g. refer to a magnetic connector, a coil, etc.. The term “movable mechanical component” especially refers to a mechanical component that is configured to move (e.g. rotational or translational), whereby heat may be generated, or which may move due to generation of heat. For instance, the movable mechanical component may include a motor, such as a fuel motor or an electric motor, a ball bearing, etc. etc. Alternatively, or additionally, the functional component may comprise a thermal component (e.g. configured to cool or to heat an electrical component). Hence, the functional component may be configured to generate heat or to scavenge heat, etc..

Especially, the invention provides a 3D item comprising a heat sink. Hence, the heat sink may be a 3D printed item. Therefore, in yet a further aspect the invention also provides a 3D item comprising 3D printed material wherein the 3D item comprises a heat sink comprising a plurality of layers of 3D printed material defining a heat receiving face, wherein the plurality of layers of 3D printed material are especially configured parallel to planes perpendicular to the heat receiving face, wherein the 3D printed material further comprises particles embedded in the 3D printed material, wherein the particles have an anisotropic thermal conductivity, wherein the particles are available in the 3D printed material in specific embodiments in an amount selected from the range of at maximum 40 vol. %, even more especially in an amount of at maximum 35 vol. %, such as at maximum 30 vol. % relative to the total volume of the 3D printed material (of the respective layers). Even more especially, the particles are available in the 3D printed material in an amount selected from the range of at least 5 vol. %, such as at least 10 vol. %, relative to the total volume of the 3D printed material (of the respective layers). Further, especially the (respective) layers of 3D printed material have layer heights (H), which are in specific embodiments selected from the range of at maximum 1 mm, even more especially at maximum 800 gm. Further, layer widths (W) are especially at least 0.8 mm, such as especially at least 1 mm.

As indicated above, the 3D printed heat sink may especially be provided in combination with a functional component, for which the heat sink may provide its heat sinking function. Therefore, in yet a further aspect the invention also provides a system comprising (i) a functional component generating heat during use, and (ii) the 3D item as defined herein, wherein the heat receiving face of the heat sink is in thermal contact with the functional component. The term “heat receiving face” may in embodiments also refer to a plurality of (different) heat receiving faces.

Further, in yet an aspect the invention provides an arrangement comprising (i) a functional component generating heat during use, and (ii) the 3D item as defined herein, wherein the heat receiving face of the (3D printed) heat sink is in thermal contact with the functional component. The functional component may be in physical contact with the heat sink or is via a thermally conductive medium, such as an aluminum element, or other thermally conductive medium (see also below), in thermal contact with the heat sink.

A “heat sink” can be defined as a passive heat exchanger that cools a device by dissipating heat into the surrounding medium. A heat sink is especially designed to maximize its surface area in contact with the cooling medium surrounding it, such as the air. The heat sink and the functional element may be in physical contact with each other. However, alternatively or additionally, there may be a thermally conductive medium in between, such as a thermal adhesive or thermal grease. Further, alternatively or additionally, a heat pipe may be configured between the functional element and the heat sink. Such heat pipe may be used to transfer heat from the functional element to the heat sink, and the heat sink may be used to dissipate the thermal energy to the environment. Hence, the heat sink is configured to dissipate thermal energy from the functional element, especially the light source (when in operation). The functional component and the heat sink, especially its heat receiving face, are configured in thermal contact with each other. This may include physical contact. However, at a non-zero distance, there may be still thermal contact, such as up to about 100 μm. Further, some parts of the heat receiving face may be in contact with the functional component and others may not. Likewise, some parts of the functional component may be in contact with the heat receiving face and other may not. Especially, the functional component includes a face that matches in shape at least part of the heat receiving face and/or the heat receiving face includes a face that matches in shape at least part of the functional component. Over the area wherein the faces match, the average distance may be smaller than 100 μm, such as smaller than 50 μm, for a good thermal transfer, such as smaller than 20 μm.

As indicated above, an example of a functional component is a light source. In specific embodiments, the heat sink may be used for dissipating heat from a light source, such as a solid state light source.

The term “light source” may refer to a semiconductor light-emitting device, such as a light emitting diode (LEDs), a resonant cavity light emitting diode (RCLED), a vertical cavity laser diode (VCSELs), an edge emitting laser, etc.. The term “light source” may also refer to an organic light-emitting diode, such as a passive-matrix (PMOLED) or an active-matrix (AMOLED). In a specific embodiment, the light source comprises a solid state light source (such as a LED or laser diode). In an embodiment, the light source comprises a LED (light emitting diode). The term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of semiconductor light sources may be configured on the same substrate. In embodiments, a COB is a multi LED chip configured together as a single lighting module. The term “light source” may also relate to a plurality of light sources, such as 2-2000 solid state light sources.

Therefore, in specific embodiments, the system (such as defined above) may comprise a lighting system comprising a light source, wherein the functional component comprises the light source. In this way, heat from the light source may be dissipated away via the 3D printed heat sink.

Below, some embodiments in relation to the method and in relation to the 3D printed item are further elucidated. In general, the embodiments in relation to the 3D printing method apply also to the 3D printed item, and vice versa. Essentially all embodiments described herein in relation to the 3D printing method and/or 3D printed item also relate to the system (or arrangement) comprising such item. Further, essentially all embodiments described in relation to the method also apply to a computer program product that may execute such method (see also below).

Especially, the method comprises layer-wise depositing 3D printable material to provide the 3D item comprising 3D printed material. As indicated above, the method may comprises depositing—during a printing stage—3D printable material. Herein, the term “3D printable material” refers to the material to be deposited or printed, and the term “3D printed material” refers to the material that is obtained after deposition. These materials may be essentially the same, as the 3D printable material may especially refer to the material in a printer head or extruder at elevated temperature and the 3D printed material refers to the same material, but in a later stage when deposited. The 3D printable material is printed as a filament and deposited as such. The 3D printable material may be provided as filament or may be formed into a filament. Hence, whatever starting materials are applied, a filament comprising 3D printable material is provided by the printer head and 3D printed.

Herein, the term “3D printable material” may also be indicated as “printable material. The term “polymeric material” may in embodiments refer to a blend of different polymers, but may in embodiments also refer to essentially a single polymer type with different polymer chain lengths. Hence, the terms “polymeric material” or “polymer” may refer to a single type of polymers but may also refer to a plurality of different polymers. The term “printable material” may refer to a single type of printable material but may also refer to a plurality of different printable materials. The term “printed material” may refer to a single type of printed material but may also refer to a plurality of different printed materials.

Hence, the term “3D printable material” may also refer to a combination of two or more materials. In general, these (polymeric) materials have a glass transition temperature T_{g} and/or a melting temperature Tₘ. The 3D printable material will be heated by the 3D printer before it leaves the nozzle to a temperature of at least the glass transition temperature, and in general at least the melting temperature. Hence, in a specific embodiment the 3D printable material comprises a thermoplastic polymer having a glass transition temperature (T_{g}) and/or a melting point (Tₘ), and the printer head action comprises heating the 3D printable material above the glass transition and if it is a semi-crystalline polymer above the melting temperature. In yet another embodiment, the 3D printable material comprises a (thermoplastic) polymer having a melting point (Tₘ), and the printer head action comprises heating the 3D printable material to be deposited on the receiver item to a temperature of at least the melting point. The glass transition temperature is in general not the same thing as the melting temperature. Melting is a transition which occurs in crystalline polymers. Melting happens when the polymer chains fall out of their crystal structures, and become a disordered liquid. The glass transition is a transition which happens to amorphous polymers; that is, polymers whose chains are not arranged in ordered crystals, but are just strewn around in any fashion, even though they are in the solid state. Polymers can be amorphous, essentially having a glass transition temperature and not a melting temperature or can be (semi) crystalline, in general having both a glass transition temperature and a melting temperature, with in general the latter being larger than the former.

As indicated above, the invention thus provides a method comprising providing a filament of 3D printable material and printing during a printing stage said 3D printable material on a substrate, to provide said 3D item.

Materials that may especially qualify as 3D printable materials may be selected from the group consisting of metals, glasses, thermoplastic polymers, silicones, etc. Especially, the 3D printable material comprises a (thermoplastic) polymer selected from the group consisting of ABS (acrylonitrile butadiene styrene), Nylon (or polyamide), Acetate (or cellulose), PLA (poly lactic acid), terephthalate (such as PET polyethylene terephthalate), Acrylic (polymethylacrylate, Perspex, polymethylmethacrylate, PMMA), Polypropylene (or polypropene), Polycarbonate (PC), Polystyrene (PS), PE (such as expanded-high impact-Polythene (or polyethene), Low density (LDPE) High density (HDPE)), PVC (polyvinyl chloride) Polychloroethene, etc.. Optionally, the 3D printable material comprises a 3D printable material selected from the group consisting of Urea formaldehyde, Polyester resin, Epoxy resin, Melamine formaldehyde, thermoplastic elastomer such as thermoplastic elastomer based on copolyester elastomers, polyurethane elastomers, polyamide elastomers polyolefine based elastomers, styrene based elastomers, etc.. Optionally, the 3D printable material comprises a 3D printable material selected from the group consisting of a polysulfone. Elastomers, especially thermoplastic elastomers, are especially interesting as they are flexible and may help obtaining relatively more flexible filaments comprising the thermally conductive material.

In specific embodiments, the 3D printable material comprises one or more of polycarbonate and, thermoplastic elastomer, and polyethylene. Thermoplastic elastomer materials and polyethylene may especially be useful in view of their flexibility. PC appears to have relatively good optical properties.

A thermoplastic elastomer may comprise one or more of styrenic block copolymers (TPS (TPE-s)), thermoplastic polyolefin elastomers (TPO (TPE-o)), thermoplastic vulcanizates (TPV (TPE-v or TPV)), thermoplastic polyurethanes (TPU (TPU)), thermoplastic copolyesters (TPC (TPE-E)), and thermoplastic polyamides (TPA (TPE-A)).

Hence, especially suitable herein are one or more of polycarbonate, polyethylene, polypropylene, and copolyester based thermoplastic elastomer.

As indicated above, the 3D printable material further comprises particles embedded in the 3D printable material. The 3D printable materials may in embodiments comprise different types of particles. The particles which are indicated as “particles” or “the particles” in general refer to particles have an anisotropic thermal conductivity or an anisotropic electrical conductivity, especially an anisotropic thermal conductivity. Other particles may optionally be available, and may herein be covered by the term “additive”.

The particles which have an anisotropic conductivity may consist of a single type of material or may consist of different types of materials. The latter may refer to embodiments wherein composite materials are applied and/or to embodiments wherein different types of particles are applied, i.e. a subset of particles of an anisotropic conductive material with another subset of particles of another anisotropic conductive material. The term “particles of anisotropic conductive material” and similar terms may thus refer to a particulate material that may comprise one or more different types of anisotropic conductive materials.

Especially, the particles are available in the 3D printable material in specific embodiments in an amount of at maximum 40 vol. %, even more especially at maximum 30 vol. %, relative to the total volume of the 3D printable material (in the respective layer). It appears that up to about these volume percentages, the conductivity, especially the thermal conductivity is relatively large and the 3D printable material is still printable. Above these volume percentages, the 3D printable material becomes very brittle and/or specific measures have to be taken to be able to print the 3D printable material. Especially, the particle (of anisotropic conductive material) are available in an amount of at minimum 5 vol. %, even more especially at least 10 vol. %, such as at least 15 vol. %, like at least 20 vol. %, relative to the total volume of the 3D printable material. For instance, assuming 30 vol. % (anistropically conductive) particles, 70 vol. % may essentially consist of the (thermoplastic) polymeric material, such as copolyester based thermoplastic elastomer. The polymeric material is 3D printable, and the combination of the polymeric material and particles is also 3D printable. Hence, the 3D printable material comprising particles (and polymeric material, such as e.g. defined above) is 3D printable.

The volume percentage especially refer to the 3D printable material, and thus also the respective layers that are deposited.

As indicated above, the method comprises providing layers of 3D printed material having layer heights (H), especially selected from the range of at maximum 1 mm, even more especially at maximum 800 μm. It appears that when these maximum layers heights are selected, the 3D printed material also becomes anisotropic conductive, whereas when having layer height larger than about 800 μm, the (thermal) conductivity is lower and is essentially not anisotropic anymore. In general, the smaller the layer height, the higher the anisotropic conductivity. Hence, in specific embodiments the layer height is at maximum 600 μm, like at maximum 400 μm. Especially, the layer height is at minimum about 50 μm, such as at minimum about 100 μm. For instance, the layer height may be in the range of 100-400 μm. By using these layer heights, the (anisotropic conductive) particles are aligned parallel to the layer, whereby the anisotropic conductivity may be obtained.

The particles may comprise one or more of flake-shaped particles and needle-shape particles, i.e. the particles may have a flake shape or a needle shape, or combinations of different shaped particles are used, including flake-shaped and needle-shaped particles.

The flakes, as mentioned herein, may have any shape. An example of particles with a high aspect ratio is cornflake particles. Cornflake particles are high aspect ratio flakes with ragged edges and a cornflake-like appearance. Cornflake particles may have aspect ratios in the range of 10-1.000.

In specific embodiments, the particles may irregularly be shaped. In other embodiments, the particles may regularly be shaped. In yet other embodiments, the particles may comprise one or more of regularly shaped particles and irregularly shape particles, i.e. the particles may have a regular shape or an irregular needle shape, or combinations of different shaped particles are used, including regularly shaped and irregularly shaped particles.

The particles may have a unimodal particle size distribution or a polymodal size distribution.

Especially, in embodiments for at least part of the total number of particles the particle length (L1) is selected from the range up to 500 μm, such as up to 400 μm, like up to 300 μm. Especially, in embodiments for at least part of the total number of particles the particle length (L1) is selected from the range of at least 10 μm. Hence, in specific embodiments the particles have a longest dimension (L1) selected from the range of 10-200 μm, and wherein the particles.

The term “particle length” is herein also indicated as “longest dimension” or “first dimension”.

Especially, these dimensions of the longest length apply to at least about 50 wt % of the (anisotropically conductive) particles in the 3D printable material or 3D printed material, respectively, such as at least 80 wt %, like at least 90 wt %. Hence, in embodiments essentially all the particles have such longest length.

The particles may have a particle height. Especially, in embodiments the particle height (L2) may be selected from the range of 0.1-100 μm, even more especially the particle height (L2) may be selected from the range of 0.1-20 μm.

In the case of needle-shaped particles, the particle height may essentially be the diameter.

The term “particle height” is herein also indicated as “shortest dimension” or “second dimension”.

Especially, these dimensions of the shortest length apply to at least about 50 wt % of the (anisotropically conductive) particles in the 3D printable material or 3D printed material, respectively, such as at least 80 wt %, like at least 90 wt %. Hence, in embodiments essentially all the particles have such particle height.

Especially, the particles may have an aspect ratio AR defined as the ratio of the particle length (L1) and the particle height (L2). In specific embodiments, AR≥2, even more especially, AR≥5. Especially, AR≥10, such as AR≥20.

Especially, these values of the (first) aspect ratio apply to at least about 50 wt % of the (anisotropically conductive) particles in the 3D printable material or 3D printed material, respectively, such as at least 80 wt %, like at least 90 wt %. Hence, in embodiments essentially all the particles have such ratio.

The particles may have a particle width (L3).

In the case of needle-shaped particles, the particle width may essentially be the diameter, and may thus be essentially the same as the particle height (see above).

In case of flake-like particles, the particle width may be in the same order of magnitude, such as in the same range, as the particle length (see above.

The term “particle width” is herein also indicated as “third dimension”.

Especially, these dimensions of the particle width apply to at least about 50 wt % of the (anisotropically conductive) particles in the 3D printable material or 3D printed material, respectively, such as at least 80 wt %, like at least 90 wt %. Hence, in embodiments essentially all the particles have such particle width.

For irregular shaped particles, but also for regular shaped articles, for the sake of easiness, the smallest rectangular cuboid (rectangular parallelepiped) enclosing the (irregular shaped) particle may be used to define the length, width and height. Hence, the term “first dimension” especially refers to the length of the smallest rectangular cuboid (rectangular parallelepiped) enclosing the irregular shaped particle.

Herein, the terms “first dimension” or “longest dimension” especially refers to the particle length. Especially, a largest dimension is the dimension in the plane of the particle. Herein, the terms “second dimension” or “shortest dimension” especially refers to the thickness of the particles. Herein, the terms “third dimension” especially refers to the width of the particles.

Especially, the method comprises printing the 3D printable material such that a third (aspect) ratio AR3 of the first length (L1) of the particles and the layer height (H) of the layers, AR3=L1/H, is selected from the range of 0.01≤AR3≤2, especially 0.1≤AR3≤1. This aspect ratio AR3 may also be indicated as “ratio” or particle length-layer height ratio.

In specific embodiments, the particles comprise one or more of graphite (C) and boron nitride (BN). With such particles, it is possible to provide relatively highly thermally conductive materials. With the latter, it is also possible to provide a relatively highly thermally conductive material, which is essentially electrically non-conductive.

Hence, in specific embodiments the particles comprise non-spherical graphite particles. Alternatively or additionally, the particles comprise non-spherical boron nitride particles.

As indicated above, the layer height and/or layer width are especially controlled. This may be done via one or more parameters. Therefore, in embodiments the method may further comprise controlling the layer height (H) and/or a layer width (W) by (controlling) one or more of a speed of movement a of a printer head, a rate of 3D printable material extrusion through a nozzle of the printer head, and a distance between the nozzle and a receiver item on which the 3D printable material is printed. Especially, the layer width (W) may be maintained at at least 1 mm. Further, the method may especially comprise printing the 3D printable material such that a ratio AR3 of the longest dimension (L1) of the particles and the layer height (H) of the layers AR3=L1/H is selected from the range of 0.01≤AR3≤2.

As indicated above, the present method is especially useful for fused deposition modelling. Therefore, in embodiments the method may comprise using a fused deposition modeling 3D printer for layer-wise depositing the 3D printable material, wherein the fused deposition modeling 3D printer comprises a printer head with a nozzle. It appears useful for the present method, that the nozzle is relatively large. Therefore, in embodiments the nozzle has an equivalent circular diameter of at least 1 mm, even more especially the nozzle has an equivalent circular diameter selected from the range of 1-5 mm. The equivalent circular diameter (or ECD) of an irregularly shaped two-dimensional shape is the diameter of a circle of equivalent area. For instance, the equivalent circular diameter of a square with side a is 2*a*SQRT(1/π). In embodiments, the nozzle is round (i.e. the nozzle opening is essentially circular).

The 3D printable material especially comprises a thermoplastic material. It appears that some thermoplastic materials may better be used for the present 3D printing process than other 3D printable materials. For instance, 3D printable material comprising ultra-high molecular weight polymer and the (anisotropic conductive) particles appear to be essentially non-printable.

Therefore, in specific embodiments the 3D printable material comprises a thermoplastic material having a weight averaged molecular weight of at maximum 1*10⁶ Dalton, such as especially at maximum 5*10⁵ Dalton, like even more especially 1*10⁵ Dalton. Especially, at least 50 wt. % of the thermoplastic material, such as at least 80 wt %, like at least 90 wt %, consists of a polymeric material having a weight averaged molecular weight of at maximum 1*10⁵ Dalton. Hence, in embodiments the 3D printable material does not comprise ultrahigh molecular weight (UHMW) polymer.

As indicated above, the 3D printable material comprises the thermoplastic material and the (anisotropic conductive) particles. Especially, at least 40 vol. % of the 3D printable material consists of the thermoplastic material (relative to the total volume of the 3D printable material.

As indicated above, in addition to the (anisotropic conductive) particles, there may be further additive material, be it particulate or be it non-particulate. The availability of such additive may especially be maximized. Especially, in embodiments the 3D printable comprises at maximum 30 vol. % of a further additive (relative to the total volume of the 3D printable material), wherein the further additive is selected from the group of a polymeric additive and an inorganic additive, other than the particles having an anisotropic thermal conductivity.

The printable material may thus in embodiments comprise two phases. The printable material may comprise a phase of printable polymeric material, especially thermoplastic material (see also below), which phase is especially an essentially continuous phase. In this continuous phase of thermoplastic material polymer additives such as one or more of antioxidant, heat stabilizer, light stabilizer, ultraviolet light stabilizer, ultraviolet light absorbing additive, near infrared light absorbing additive, infrared light absorbing additive, plasticizer, lubricant, release agent, antistatic agent, anti-fog agent, antimicrobial agent, colorant, laser marking additive, surface effect additive, radiation stabilizer, flame retardant, anti-drip agent may be present. The additive may have useful properties selected from optical properties, mechanical properties, electrical properties, thermal properties, and mechanical properties (see also above).

When the additive is particulate and has an anisotropic thermal conductivity, the additive is thus indicated as particulate material having an anisotropic thermal conductivity. Likewise, when the additive is particulate and has an anisotropic electrical conductivity, the additive is thus indicated as particulate material having an anisotropic electrical conductivity. Essentially all other additives are indicated as “additive”. Such additive(s), other than the particles having an anisotropic (thermal) conductivity, may be available to at maximum 30 vol. % (relative to the total volume of the 3D printable material), especially up to at maximum 20 vol. %. Especially, the volume occupied by the additive is lower than the volume occupied by the particles having an anisotropic (thermal) conductivity.

The printable material in embodiments may comprise particulate material, i.e. particles embedded in the printable polymeric material, which particles form a substantially discontinuous phase. The number of particles in the total mixture is especially not larger than 60 vol. %, relative to the total volume of the printable material (including the (anisotropically conductive) particles) especially in applications for reducing thermal expansion coefficient. For optical and surface related effect number of particles in the total mixture is equal to or less than 20 vol. %, such as up to 10 vol. %, relative to the total volume of the printable material (including the particles). Hence, the 3D printable material especially refers to a continuous phase of essentially thermoplastic material, wherein other materials, such as particles, may be embedded. Likewise, the 3D printed material especially refers to a continuous phase of essentially thermoplastic material, wherein other materials, such as particles, are embedded. The particles may comprise one or more additives as defined above. Hence, in embodiments the 3D printable materials may comprises particulate additives.

As indicated above, the method may be used to 3D print a heat sink. When doing so, care has to be taken of the anisotropic aspect of the (thermal) conductivity. Dependent upon the 3D printing direction, the thermal conductivity may be in the wrong plane. The thermal conductivity is along the 3D printed layers. Hence, would the layers be parallel to the surface of the heat sink that is in thermal contact with the functional component, heat transfer may be inhibited. Hence, the method may herein also include a stage designing the 3D printing method such, that the direction wherein the highest (thermal) conductivity is available, is configured perpendicular to a surface that is configured to (later, in a system) receive heat from a functional component.

Hence, the 3D item may be a heat sink, wherein the heat sink comprises a heat receiving face, wherein the method comprises layer-wise depositing the 3D printable material to provide a plurality of layers of the 3D printed material whereby the heat receiving face is created, wherein the plurality of layers of 3D printed material are configured parallel to planes perpendicular to the heat receiving face.

The printable material is printed on a receiver item. Especially, the receiver item can be the building platform or can be comprised by the building platform. The receiver item can also be heated during 3D printing. However, the receiver item may also be cooled during 3D printing.

The phrase “printing on a receiver item” and similar phrases include amongst others directly printing on the receiver item, or printing on a coating on the receiver item, or printing on 3D printed material earlier printed on the receiver item. The term “receiver item” may refer to a printing platform, a print bed, a substrate, a support, a build plate, or a building platform, etc.. Instead of the term “receiver item” also the term “substrate” may be used. The phrase “printing on a receiver item” and similar phrases include amongst others also printing on a separate substrate on or comprised by a printing platform, a print bed, a support, a build plate, or a building platform, etc.. Therefore, the phrase “printing on a substrate” and similar phrases include amongst others directly printing on the substrate, or printing on a coating on the substrate or printing on 3D printed material earlier printed on the substrate. Here below, further the term substrate is used, which may refer to a printing platform, a print bed, a substrate, a support, a build plate, or a building platform, etc., or a separate substrate thereon or comprised thereby.

Layer by layer printable material is deposited, by which the 3D printed item is generated (during the printing stage). The 3D printed item may show a characteristic ribbed structures (originating from the deposited filaments). However, it may also be possible that after a printing stage, a further stage is executed, such as a finalization stage. This stage may include removing the printed item from the receiver item and/or one or more post processing actions. One or more post processing actions may be executed before removing the printed item from the receiver item and/or one more post processing actions may be executed after removing the printed item from the receiver item. Post processing may include e.g. one or more of polishing, coating, adding a functional component, etc.. Post-processing may include smoothening the ribbed structures, which may lead to an essentially smooth surface.

Further, the invention relates to a software product that can be used to execute the method described herein. Therefore, in yet a further aspect the invention also provides a computer program product, when running on a computer which is functionally coupled to or comprised by a fused deposition modeling 3D printer, is capable of bringing about the method as described herein.

Some specific embodiments in relation to the 3D printed item have already been elucidated below when discussing the method. Below, some specific embodiments in relation to the 3D printed item are discussed in more detail.

As indicated above, the 3D printed item may comprise, or may be a heat sink. Especially, such heat sink comprises a plurality of fins for dissipating heat. Hence, the fins are also 3D printed.

In specific embodiments, the particles (of the 3D item) comprise non-spherical graphite particles and/or non-spherical boron nitride particles. These particles may especially have a longest dimension (L1) selected from the range of 10-200 μm (see also above wherein the sizes and shapes of the particles are defined (in more detail)). In embodiments, the particles may (thus) comprise one or more of flake-shaped particles and needle-shape particles.

Further, as indicated above, the particles may (thus) comprise one or more of graphite and boron nitride. In specific embodiments, the 3D printed material comprises one or more of polycarbonate and a silicone rubber.

In specific embodiments of the 3D printed item, the item comprises layers, with especially a third aspect ratio AR3 of the first length (L1) of the particles and the layer height (H) of the layers, AR3=L1/H, being selected from the range of 0.01≤AR3≤2, especially 0.1≤AR3≤1. Essentially all layers comprising the (anisotropically conductive) particles may comply with such aspect ratio.

In embodiments, the 3D printed material especially comprises a thermoplastic material having a weight averaged molecular weight of at maximum 1*10⁵ Dalton. As indicated above, especially at least 40 vol. % of the 3D printed material consists of the thermoplastic material. optionally, the 3D printed material comprises at maximum 30 vol. % of a further additive, wherein the further additive is selected from the group of a polymeric additive, such as a plasticizer additive, and an inorganic additive, other than the particles having an anisotropic thermal (and/or electrical) conductivity.

Returning to the 3D printing process, a specific 3D printer may be used to provide the 3D printed item described herein. Therefore, in yet a further aspect the invention also provides a fused deposition modeling 3D printer, comprising (a) a printer head comprising a printer nozzle, and (b) a 3D printable material providing device configured to provide 3D printable material to the printer head, wherein the fused deposition modeling 3D printer is configured to provide said 3D printable material, and wherein the printer nozzle (or “nozzle”) especially has an equivalent circular diameter of at least 1 mm, such as in the range of 1-5 mm, like at least 1.2 mm.

The 3D printable material providing device may provide a filament comprising 3D printable material to the printer head or may provide the 3D printable material as such, with the printer head creating the filament comprising 3D printable material. Hence, in embodiments the invention provides a fused deposition modeling 3D printer, comprising (a) a printer head comprising a printer nozzle, and (b) a filament providing device configured to provide a filament comprising 3D printable material to the printer head, wherein the fused deposition modeling 3D printer is configured to provide said 3D printable material to a substrate, wherein the printer nozzle (or “nozzle”) especially has an equivalent circular diameter of at least 1 mm, such as in the range of 1-5 mm.

Especially, the 3D printer comprises a controller (or is functionally coupled to a controller) that is configured to execute in a controlling mode (or “operation mode”) the method as described herein.

The system, or apparatus, or device may execute an action in a “mode” or “operation mode” or “mode of operation”. Likewise, in a method an action or stage, or step may be executed in a “mode” or “operation mode” or “mode of operation”. The term “mode” may also be indicated as “controlling mode”. This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Instead of the term “fused deposition modeling (FDM) 3D printer” shortly the terms “3D printer”, “FDM printer” or “printer” may be used. The printer nozzle may also be indicated as “nozzle” or sometimes as “extruder nozzle”.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1a-1c schematically depict some general aspects of the 3D printer and of an embodiment of 3D printed material;

FIG. 2a-2e schematically depict some aspects of embodiments of particles, with some of the shapes being depicted for reference purposes;

FIGS. 3a-3b schematically depict some further aspects of the invention;

FIGS. 4a-4d show some thermoconductive results; and

FIGS. 5a-5e schematically show some embodiments and aspects.

The schematic drawings are not necessarily to scale.

### DETAILED DESCRIPTION OF THE EMBODIMENTS

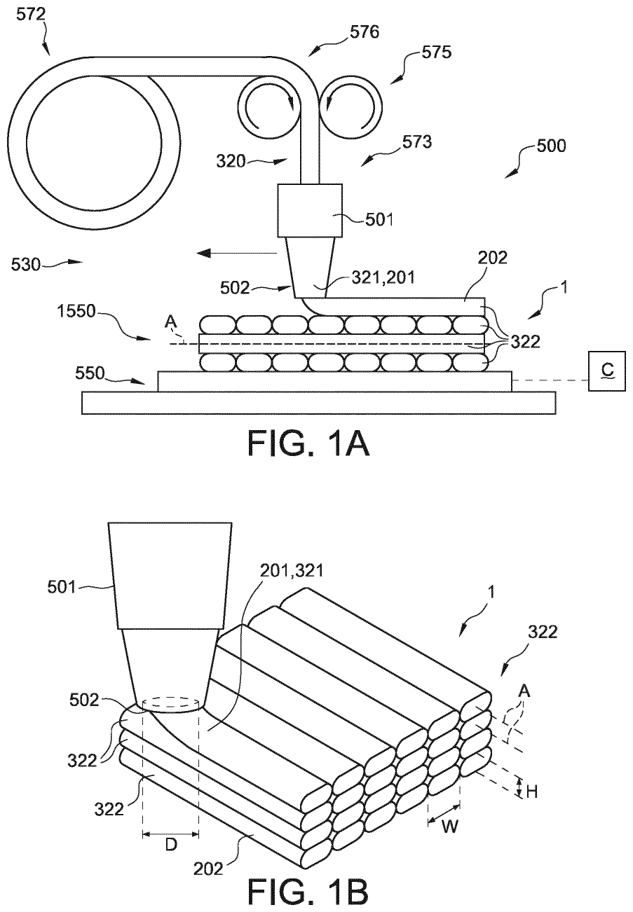

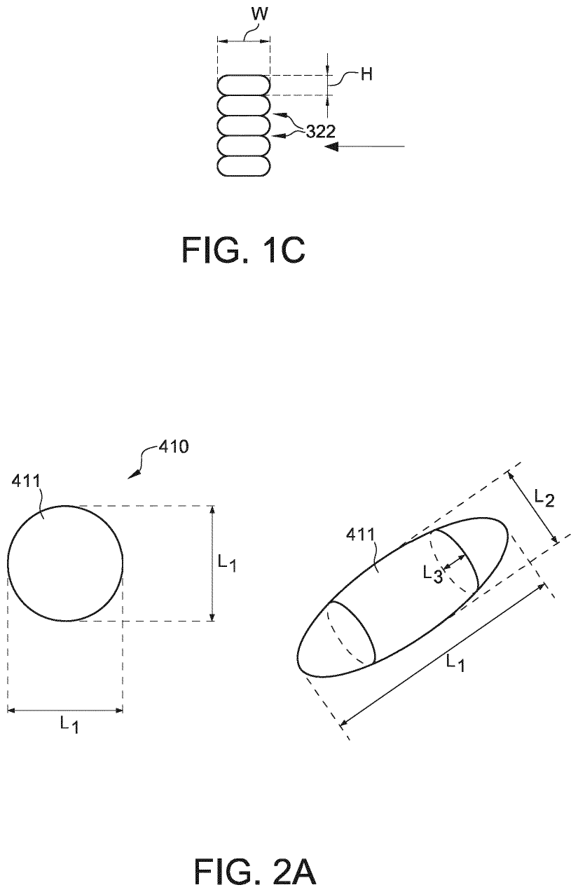

FIG. 1a schematically depicts some aspects of the 3D printer. Reference 500 indicates a 3D printer. Reference 530 indicates the functional unit configured to 3D print, especially FDM 3D printing; this reference may also indicate the 3D printing stage unit. Here, only the printer head for providing 3D printed material, such as a FDM 3D printer head is schematically depicted. Reference 501 indicates the printer head. The 3D printer of the present invention may especially include a plurality of printer heads, though other embodiments are also possible. Reference 502 indicates a printer nozzle. The 3D printer of the present invention may especially include a plurality of printer nozzles, though other embodiments are also possible. Reference 321 indicates a filament of printable 3D printable material (such as indicated above). For the sake of clarity, not all features of the 3D printer have been depicted, only those that are of especial relevance for the present invention (see further also below).

The 3D printer 500 is configured to generate a 3D item 1 by layer-wise depositing on a receiver item 550, which may in embodiments at least temporarily be cooled, a plurality of filaments 321 wherein each filament 310 comprises 3D printable material 201, such as having a melting point Tₘ. The 3D printable material 201 may be deposited on a substrate 1550 (during the printing stage).

The 3D printer 500 is configured to heat the filament material upstream of the printer nozzle 502. This may e.g. be done with a device comprising one or more of an extrusion and/or heating function. Such device is indicated with reference 573, and is arranged upstream from the printer nozzle 502 (i.e. in time before the filament material leaves the printer nozzle 502). The printer head 501 may (thus) include a liquefier or heater. Reference 201 indicates printable material. When deposited, this material is indicated as (3D) printed material, which is indicated with reference 202.

Reference 572 indicates a spool or roller with material, especially in the form of a wire, which may be indicated as filament 320. The 3D printer 500 transforms this in a filament 321 downstream of the printer nozzle which becomes a layer 322 on the receiver item or on already deposited printed material. In general, the diameter of the filament 321 downstream of the nozzle is reduced relative to the diameter of the filament 322 upstream of the printer head. Hence, the printer nozzle is sometimes (also) indicated as extruder nozzle. Arranging layer 322 by layer 322 and/or layer 322t on layer 322, a 3D item 1 may be formed. Reference 575 indicates the filament providing device, which here amongst others include the spool or roller and the driver wheels, indicated with reference 576.

Reference A indicates a longitudinal axis or filament axis.

Reference C schematically depicts a control system, such as especially a temperature control system configured to control the temperature of the receiver item 550. The control system C may include a heater which is able to heat the receiver item 550 to at least a temperature of 50° C., but especially up to a range of about 350° C., such as at least 200° C.

Alternatively or additionally, in embodiments the receiver plate may also be moveable in one or two directions in the x-y plane (horizontal plane). Further, alternatively or additionally, in embodiments the receiver plate may also be rotatable about z axis (vertical). Hence, the control system may move the receiver plate in one or more of the x-direction, y-direction, and z-direction.

Alternatively, the printer can have a head can also rotate during printing. Such a printer has an advantage that the printed material cannot rotate during printing.

Layers are indicated with reference 322, and have a layer height H and a layer width W.

Note that the 3D printable material is not necessarily provided as filament 320 to the printer head. Further, the filament 320 may also be produced in the 3D printer 500 from pieces of 3D printable material.

Reference D indicates the diameter of the nozzle (through which the 3D printable material 201 is forced).

FIG. 1b schematically depicts in 3D in more detail the printing of the 3D item 1 under construction. Here, in this schematic drawing the ends of the filaments 321 in a single plane are not interconnected, though in reality this may in embodiments be the case. Reference H indicates the height of a layer. Layers are indicated with reference 203. Here, the layers have an essentially circular cross-section. Often, however, they may be flattened, such as having an outer shape resembling a flat oval tube or flat oval duct (i.e. a circular shaped bar having a diameter that is compressed to have a smaller height than width, wherein the sides (defining the width) are (still) rounded).

Hence, FIGS. 1a-1b schematically depict some aspects of a fused deposition modeling 3D printer 500, comprising (a) a first printer head 501 comprising a printer nozzle 502, (b) a filament providing device 575 configured to provide a filament 321 comprising 3D printable material 201 to the first printer head 501, and optionally (c) a receiver item 550. In FIGS. 1a-1b, the first or second printable material or the first or second printed material are indicated with the general indications printable material 201 and printed material 202. Directly downstream of the nozzle 502, the filament 321 with 3D printable material becomes, when deposited, layer 322 with 3D printed material 202.

FIG. 1c schematically depicts a stack of 3D printed layers 322, each having a layer height H and a layer width W. Note that in embodiments the layer width and/or layer height may differ for two or more layers 322.

Referring to FIGS. 1a-1c, the filament of 3D printable material that is deposited leads to a layer having a height H (and width W). Depositing layer 322 after layer 322, the 3D item 1 is generated.

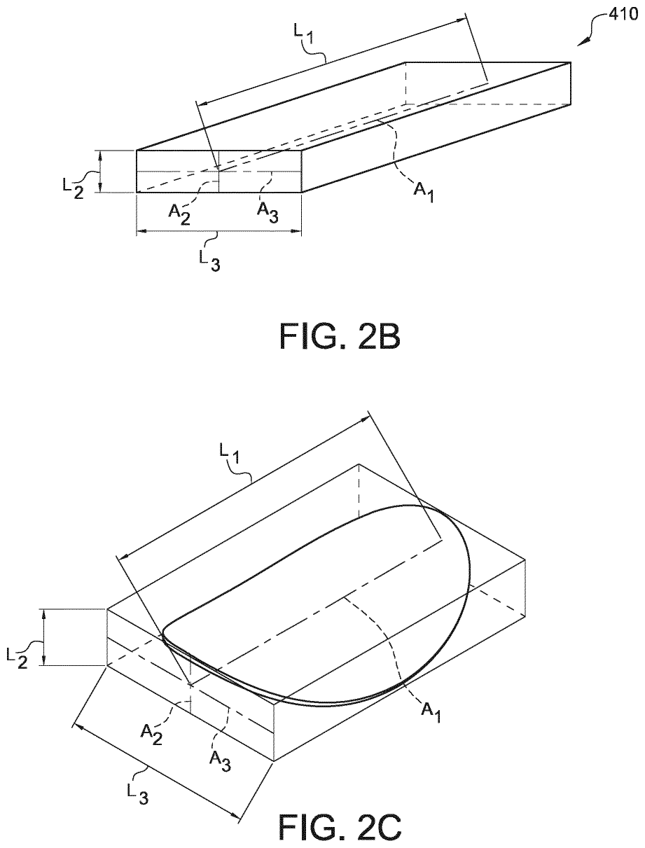

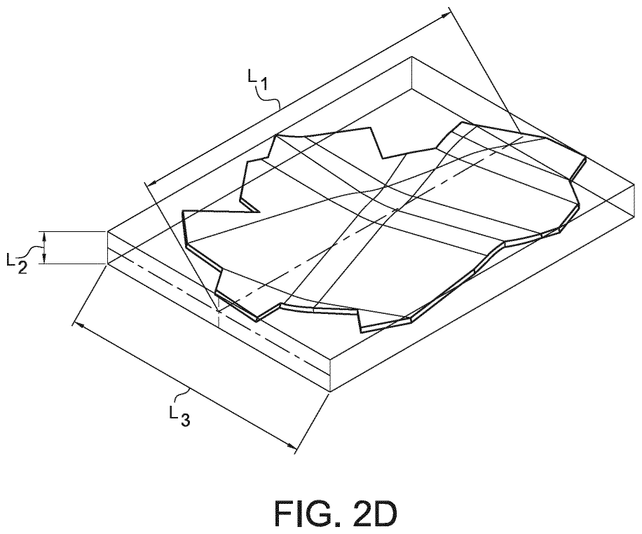

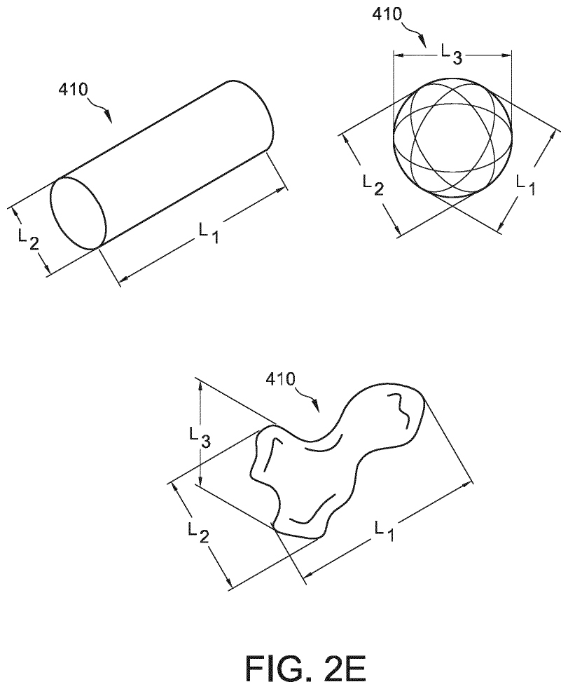

FIG. 2a schematically depicts for the sake of understanding particles and some aspects thereof. Note that the particles used in the present invention are especially relative flat, see e.g. FIG. 2d.

The particles comprise a material 411, or may essentially consist of such material 411. The particles 410 have a first dimension or length L1. In the left example, L1 is essentially the diameter of the essentially spherical particle. On the right side a particle is depicted which has non spherical shape, such as an elongated particle 410. Here, by way of example L1 is the particle length. L2 and L3 can be seen as width and height. Of course, the particles may comprise a combination of differently shaped particles.

FIGS. 2b-2e schematically depict some aspects of the particles 410. Some particles 410 have a longest dimension A1 having a longest dimension length L1 and a shortest dimension A2 having a shortest dimension length L2. As can be seen from the drawings, the longest dimension length L1 and the shortest dimension length L2 have a first aspect ratio larger than 1. FIG. 2b schematically depicts a particle 410 in 3D, with the particle 410 having a length, height and width, with the particle (or flake) essentially having an elongated shape. Hence, the particle may have a further (minor or main) axis, herein indicated as further dimension A3. Essentially, the particles 410 are thin particles, i.e. L2<L1, especially L2<<L1, and L2<<L3. L1 may e.g. be selected from the range of 5-200 μm; likewise L3 may be. L2 may e.g. be selected from the range of 0.1-20 μm.

FIG. 2c schematically depicts a particle that has a less regular shape such as pieces of broken glass, with a virtual smallest rectangular parallelepiped enclosing the particle.

Note that the notations L1, L2, and L3, and A1, A2 and A3 are only used to indicate the axes and their lengths, and that the numbers are only used to distinguish the axis. Further, note that the particles are not essentially oval or rectangular parallelepiped. The particles may have any shape with at least a longest dimension substantially longer than a shortest dimension or minor axes, and which may essentially be flat. Especially, particles are used that are relatively regularly formed, i.e. the remaining volume of the fictive smallest rectangular parallelepiped enclosing the particle is small, such as less than 50%, like less than 25%, of the total volume.

FIG. 2d schematically depicts a relatively irregularly shaped particle. Hence, the particulate material that is embedded in the 3D printable material or is embedded in the 3D printed material may include a broad distribution of particles sizes. A rectangular parallelepiped can be used to define the (orthogonal) dimensions with lengths L1, L2 and L3.

FIG. 2e schematically depicts cylindrical, spherical, and irregularly shaped particles, which will herein in general not be used (see also above).

As shown in FIGS. 2b-2e the terms “first dimension” or “longest dimension” especially refer to the length L1 of the smallest rectangular cuboid (rectangular parallelepiped) enclosing the irregular shaped particle. When the particle is essentially spherical the longest dimension L1, the shortest dimension L2, and the diameter are essentially the same.

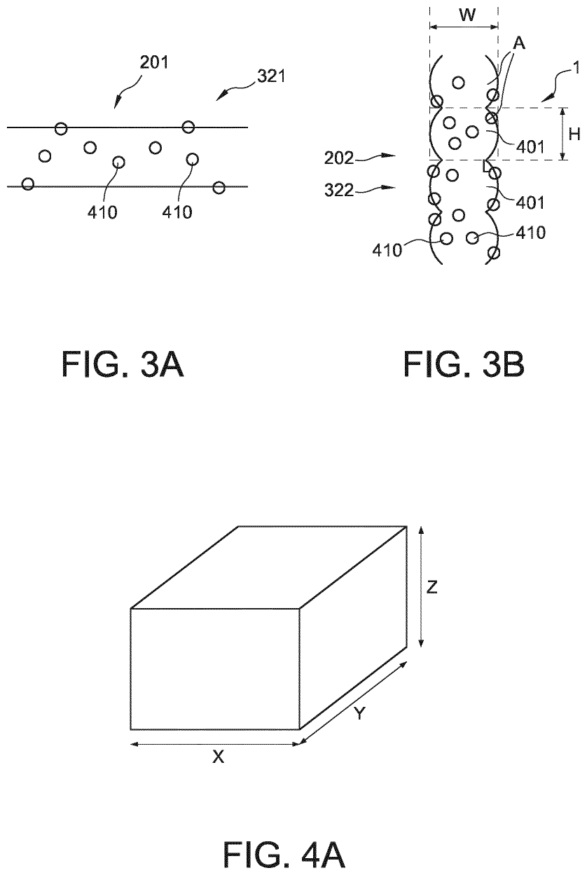

FIG. 3a schematically depicts a filament 321, such as when escaping from a printer nozzle (not depicted), which comprises 3D printable material 201. The 3D printable material comprise thermoplastic material 401 with particles 410 embedded therein.

FIG. 3b schematically depicts a 3D item 1, showing the ribbed structures (originating from the deposited filaments), having heights H. This height may also be indicated as width. Here, layers 322 with printed material 202, with heights H and widths W are schematically depicted. FIG. 3b can be seen as a stack of layers 322 of which a plurality adjacent stacks are shown in FIG. 1b.

FDM printers use a thermoplastic filament, which is heated to its melting point and then extruded, layer by layer, to create a three dimensional object.

In e.g. lighting applications for optimum functioning of LEDs efficient heat sinking is necessary.

Amongst others, herein graphite filled polymers were used to produce heat sinks It was found that printed structures show anisotropic thermal conductivity and with decreasing layer thickness the conductivity become increasingly more anisotropic. The thermal conductivity found to be highest in the plane perpendicular to the nozzle head. At layer thicknesses in the range 100-800 μm found to be optimal for realizing the desired anisotropic effect such as obtaining higher conductivity in the direction parallel to the plane while not reducing the conductivity in the direction perpendicular to the printing plane. It appeared useful that the diameter of the nozzle is above about 1 mm for facilitating printing. Hence, it is herein suggest using heat sink configurations produced by FDM printing with effective heat sinking using anisotropic thermal conductivity. In these strategies, the orientation of the heat sink design on the print platform (or the direction of the nozzle with respect to the heat sink design) is selected so that that, there is a continuous high thermal conductive path from the point of heat production to the points where heat dissipation takes place.

Polymers such as PC and Nylons filled with graphite could be used to manufacture heat sinks using injection molding. In order to obtain relatively high thermal conductivity >4 one needs to use highly graphite filled polymers.

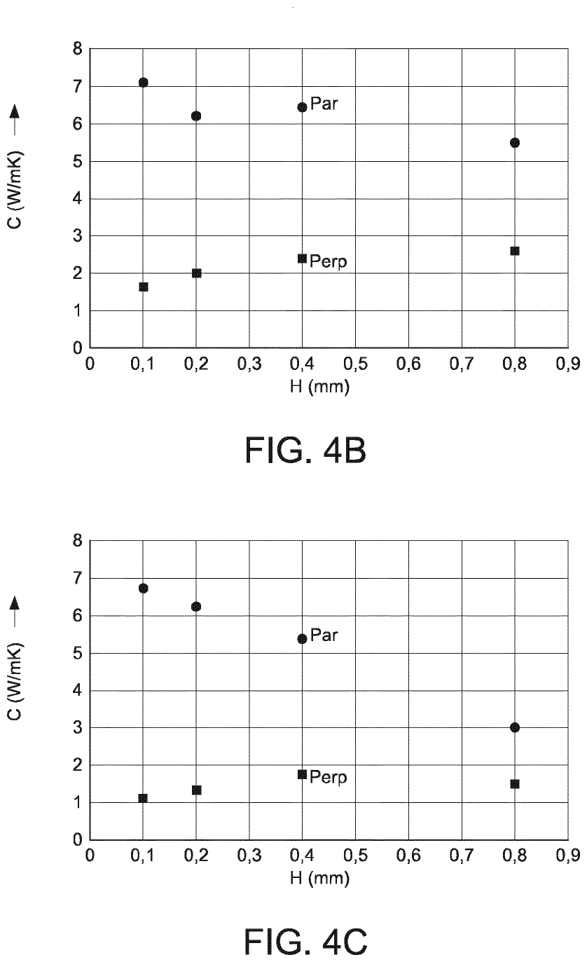

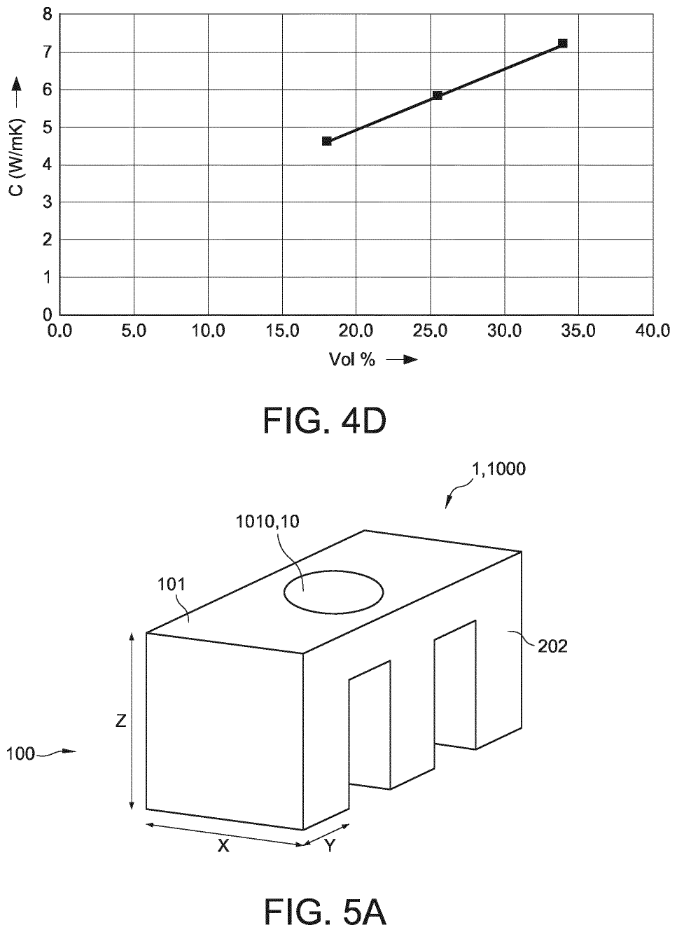

Herein, polymers are used with up to about 40 wt % (about 30 vol. %) filled with graphite. Such filaments are relatively brittle and difficult to extrude and print. Hence, for continuous printing relatively large nozzle diameters above 1 mm, or even above 2 mm to be able to print these highly filled polymers. It was also helpful to use thin filaments, such as with a thickness around 2 mm, or smaller. Filaments filled with graphite to produce cubes schematically shown in FIG. 4a by using different layer heights during printing.

The thermal conductivity of the samples was measured at different directions after printing. Thermal conductivity in the direction parallel to the plane and in the direction perpendicular to the plane for different layer thicknesses are shown in FIG. 4b for Polyamide and for Polycarbonate in FIG. 4c. On the x-axis is the height H in mm, and on the y-axis the thermal conductivity in W/mK.

It can be seen that in the range 100-800 μm the conductivity shows anisotropy. In the case of FIG. 4c at layer height of 100 μm highest thermal conductivity is obtained.

Anisotropy in thermal conductivity is related to the property of graphite. Graphite sheets show high thermal conductivity in the plane of the sheets than in direction perpendicular to the sheets. Thus the behavior observed is related to this as we induce orientation in graphite layers by controlling the layer height.

FIG. 4d shows the thermal conductivity in W/mK (y-axis) dependent upon the volume concentration vol. % (x-axis) of graphite in thermoplastic elastomer based on polyester copolymer, at a layer thickness of 200 μm parallel to the plane.

In further examples, the thermal conductivity was determined as function of volume % graphite, between about 17.5 vol. % and about 29 vol. %, with the polymeric material being elastomeric copolyester composite. The layer thickness was 400 μm. The graphite particles had a longest dimension (L1) of either 20 μm or 50 μm. the thermal conductivity for about 17.5 vol. % graphite was about 2.8 W/mK and 4.2 W/mK for the 20 μm and 50 μm graphite containing elastomeric copolyester composite 3D printed material, respectively, and for about 29 vol. % about 5.6 W/mK and about 5.9 W/mK for the 20 μm and 50 μm graphite containing elastomeric copolyester composite 3D printed material, respectively. Hence, the 50 μm graphite particles provide a relative higher thermal conductivity, especially at lower volume percentages. Further, the thermal conductivity increases with increasing volume percentage.

In order to benefit from the high thermal conductivity it is desirable that the heat sink design orientation on the print platform is selected so that that in direction of heat spreading needs to take place the printed object has the highest heat conductivity.

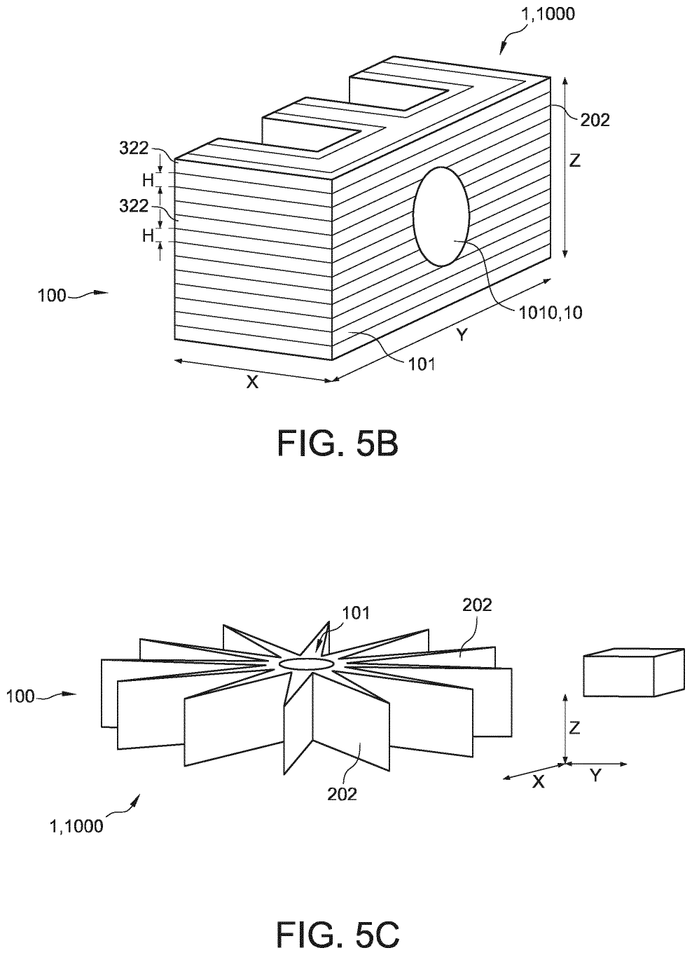

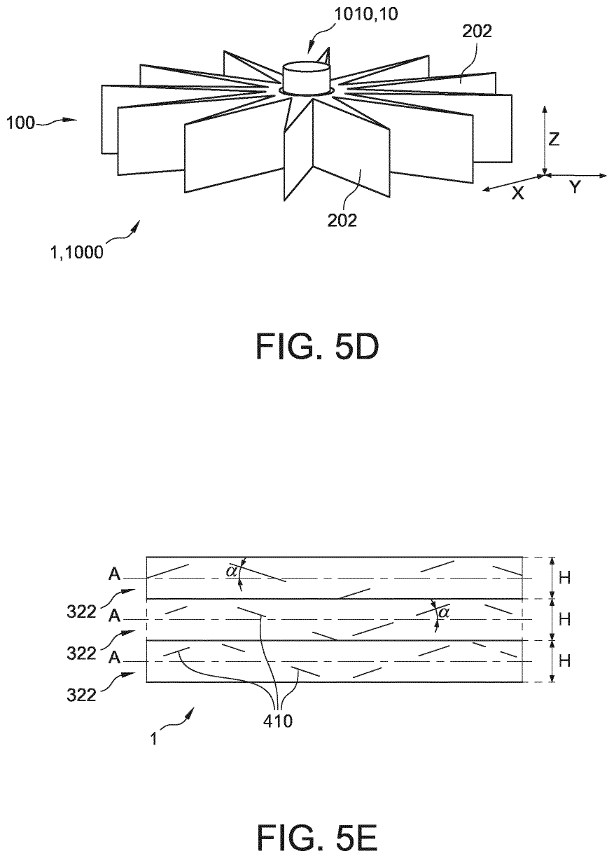

In the heat sink shown in FIG. 5a below, the heat sink was printed as shown above the XY plane high heat sinking is obtained while in the z direction thermal conductivity is low. When a light source 10, such as a LED, is placed on top heat is spread in the XY plane but as in the z direction heat is not high conductive path. A light source is an example of a functional component 1010. Of course, the invention may also be applied for other functional components.

It may therefore be relevant to choose the orientation of the heat sink during printing as shown in FIG. 5b. In this case the high thermal conductivity is in the x-y plane. Thus heat can be spread continuously first towards the fins along y axis and then along the fins along x axis where the heat can be removed by convection or irradiation.

Likewise, a structure as schematically shown in FIG. 5c can be 3D printed, with in the middle a hole for receiving a thermal conductive (insert) element and/or a functional element. The structure shown in FIG. 5c has a good conduction in the XY plane. The hole (in the center) can be used to insert high conductive material such as aluminum. It is also possible to print thermally conductive insert element with a good conductivity in Y direction and insert it in the hole. For instance, a system as schematically shown in FIG. 5d with a relatively highly efficient heat sinking can be obtained. When using this 3D printed heatsink, or combination of heatsink, the heat generating source, such as a LED, may be configured in thermal contact with the insert, like an aluminum insert. For instance, the solid state light source may be placed on top of the insert. In such arrangement, the (aluminum) insert has a relatively high conductivity (e.g. ≥100 W/Km) (along a z direction). The insert may transport the heat to the fins. The fins, with relatively high thermal conductivity in the XY plane, may spread the heat, by which the heat is transported away from the solid state light source.

FIGS. 5b-5d schematically depict embodiments of a 3D item 1 comprising 3D printed material 202 wherein the 3D item 1 comprises a heat sink 100 comprising a plurality of layers 322 of 3D printed material 202 defining a heat receiving face 101. The plurality of layers 322 of 3D printed material 202 are configured parallel to planes 325 perpendicular to the heat receiving face 101, wherein the 3D printed material 202 further comprises particles (not shown) embedded in the 3D printed material 202, wherein the particles have an anisotropic thermal conductivity. The particles are available in the 3D printed material 202 in an amount of at maximum 30 vol. % relative to the total volume of the 3D printed material 202 (of the respective layers 322), and wherein the (respective) layers 322 of 3D printed material 202 have layer heights H selected from the range of at maximum 800 μm.

FIGS. 5b-5d also schematically depict embodiments of a system 1000 comprising a functional component 1010 generating heat during use, and the 3D item 1, wherein the heat receiving face 101 of the heat sink 100 is in thermal contact with the functional component.

Especially, the system 1000 comprises a lighting system comprising a light source 10, wherein the functional component 1010 comprises the light source 10.

Hence, in embodiments the 3D printed item may include fins extending in different directions. Further, the fins may extend essentially perpendicular to a heat receiving face. The 3D printed item may include a rotational symmetric shape. In embodiments, the heat receiving surface may be circular, such as cylindrical. The heat receiving face may be configured such that it may host a thermally conductive medium, such as a solid body of (aluminum) metal.

FIG. 5e schematically depicts in more detail an embodiment of a 3D item 1, here with—by way of example—three layers 322 with layer heights H, wherein it is shown that the particles 410 are aligned with the layers with an average orientation of the long axis of the graphite of particles being parallel to the plane of the layers. For instance, in the orientation distribution function full width at half maximum corresponds may be about 100° or smaller; the half maxima may especially be at about −50° and 50°, and the maximum at about 0° to relative to a plane through the layer 322 (parallel to a layer axis).For instance, the full width half maximum may be at maximum about 80°, like at maximum 60°. Further, the maximum is especially at about 0°±5°.

The term “substantially” herein, such as “substantially consists”, will be understood by the person skilled in the art. The term “substantially” may also include embodiments with “entirely”, “completely”, “all”, etc. Hence, in embodiments the adjective substantially may also be removed. Where applicable, the term “substantially” may also relate to 90% or higher, such as 95% or higher, especially 99% or higher, even more especially 99.5% or higher, including 100%. The term “comprise” includes also embodiments wherein the term “comprises” means “consists of”. The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices herein are amongst others described during operation. As will be clear to the person skilled in the art, the invention is not limited to methods of operation or devices in operation.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention also provides a control system that may control the apparatus or device or system, or that may execute the herein described method or process. Yet further, the invention also provides a computer program product, when running on a computer which is functionally coupled to or comprised by the apparatus or device or system, controls one or more controllable elements of such apparatus or device or system.

The invention further applies to a device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

It goes without saying that one or more of the first (printable or printed) material and second (printable or printed) material may contain fillers such as glass and fibers which do not have (to have) influence on the on T_{g} or Tₘ of the material(s).

1. A method for 3D printing a heat sink by means of fused deposition modelling, the method comprising layer-wise depositing a 3D printable material to provide a plurality of layers of a 3D printed material whereby a heat receiving face of the heat sink is created, the plurality of layers of 3D printed material being configured parallel to planes perpendicular to the heat receiving face, wherein the 3D printable material comprises particles embedded in the 3D printable material, wherein the particles have an anisotropic thermal conductivity, wherein the particles have a longest dimension selected from the range of 10-200 μm, wherein the particles are available in the 3D printable material in an amount selected from the range of 5-40 vol. % relative to the total volume of the 3D printable material, and wherein the layers of 3D printed material have layer heights selected from the range of at maximum 800 μm.

2. The method according to claim 1, wherein the particles comprise one or more of flake-shaped particles and needle-shape particles, and wherein the particles are available in the 3D printable material in an amount selected from the range of 10-40 vol. % relative to the total volume of the 3D printable material.

3. The method according to claim 1, comprising controlling the layer height and a layer width by one or more of a speed of movement a of a printer head, a rate of 3D printable material extrusion through a nozzle of the printer head, and a distance between the nozzle and a receiver item on which the 3D printable material is printed, wherein the layer width is maintained at at least 1 mm, and wherein the method comprises printing the 3D printable material such that a ratio AR3 of the longest dimension of the particles and the layer height of the layers AR3=L1/H is selected from the range of 0.01≤AR3≤2.

4. The method according to claim 1, comprising using a fused deposition modeling 3D printer for layer-wise depositing the 3D printable material, wherein the fused deposition modeling 3D printer comprises a printer head with a nozzle, wherein the nozzle has an equivalent circular diameter of at least 1 mm.

5. The method according to claim 1, wherein the particles comprise one or more of graphite and boron nitride, and wherein the 3D printable material comprises one or more of polycarbonate, polyethylene, polypropylene, and polyester based thermoplastic elastomer.

6. The method according to claim 1, wherein the 3D printable material comprises a thermoplastic material having a weight averaged molecular weight of at maximum 1*10⁵ Dalton, wherein at least 40 vol. % of the 3D printable material consists of the thermoplastic material.

7. The method according to claim 1, wherein the 3D printable comprises at maximum 30 vol. % of a further additive, wherein the further additive is selected from the group of a polymeric additive and an inorganic additive, other than the particles having an anisotropic thermal conductivity.

8. A heat sink comprising 3D printed material, wherein the heat sink comprises a plurality of layers of 3D printed material defining a heat receiving face, wherein the plurality of layers of 3D printed material are configured parallel to planes perpendicular to the heat receiving face, wherein the 3D printed material comprises a thermoplastic material having a weight averaged molecular weight of at maximum 1*10⁵ Dalton, wherein at least 40 vol. % of the 3D printed material consists of the thermoplastic material, wherein the 3D printed material further comprises particles embedded in the 3D printed material, wherein the particles have an anisotropic thermal conductivity, wherein the particles have a longest dimension selected from the range of 10-200 μm, wherein the particles are available in the 3D printed material in an amount selected from the range of 5-40 vol. % relative to the total volume of the 3D printed material, and wherein the layers of 3D printed material have layer heights selected from the range of at maximum 800 μm.

9. The heat sink according to claim 8, wherein the heat sink comprises a plurality of fins for dissipating heat.

10. The heat sink according to claim 8, wherein the particles are available in the 3D printed material in an amount selected from the range of 10-40 vol. % relative to the total volume of the 3D printed material, wherein the particles comprise one or more of flake-shaped particles and needle-shape particles, wherein the particles comprise one or more of graphite and boron nitride, and wherein the 3D printed material comprises one or more of polycarbonate, polyethylene, polypropylene, and polyester based thermoplastic elastomer.

11. The heat sink according to claim 8, wherein the 3D printed material comprises at maximum 30 vol. % of a further additive, wherein the further additive is selected from the group of a polymeric additive and an inorganic additive, other than the particles having an anisotropic thermal conductivity.

12. A system comprising a functional component generating heat during use, and the heat sink according to claim 8, wherein the heat receiving face of the heat sink is in thermal contact with the functional component.

13. The system according to claim 12, wherein the system comprises a lighting system comprising a light source, wherein the functional component comprises the light source.

14. A computer program product, when running on a computer which is functionally coupled to or comprised by a fused deposition modeling 3D printer, is capable of bringing about the method according to claim 1.
